(19) United States
(12) Patent Application Publication
(10) Pub. No.: US 2011/0061167 A1
(43) Pub. Date: Mar. 17, 2011

(54) PILLOWS WITH LARGE DIAMETER CLEAVING FOR ENHANCED LATERAL SOFTNESS

(76) Inventor: David Farley, Corona, CA (US)

(21) Appl. No.: 12/879,969

(22) Filed: Sep. 10, 2010

Related U.S. Application Data
(60) Provisional application No. 61/241,887, filed on Sep. 12, 2009.

(51) Int. Cl. A47G 9/10; B26D 1/00

(52) U.S. Cl. 5/652; 83/13

(57) ABSTRACT

A pillow including a main body having a top support surface, a bottom support surface and rounded ends joining the top and bottom support surfaces about a rounded profile. The rounded profile of the pillow has no recessed areas where a thickness of the main body decreases progressively towards an edge of the main body. The main body is made of a cellular material. The pillow includes a plurality of holes defined to extend through the main body and include openings on the top and bottom support surfaces. The holes have a constant circular cross section having a diameter of ⅝ inch or greater.

This application claims the benefit and priority of U.S. Provisional Application No. 61/241,887, filed on Sep. 12, 2009, which is herein incorporated by reference in its entirety for all purposes.

### BACKGROUND

1. Field

The present disclosure relates to a device for supporting portions of the body, and more specifically a pillow-like device including at least one surface defining a plurality of holes through the pillow to provide a higher level of softness, suppleness, elongation, and elastic performance in the lateral (horizontal) direction.

2. Description of the Related Art

Typically, “shaped” or contoured pillows are used to produce head and cervical neck support in the vertical direction. The contouring required in these types of pillows is necessarily time consuming to manufacture and, thus costly to produce.

The vertical support from these pillows is primarily provided by a shape cut into the support surface where the raw material of the pillow is not expected to deform or elongate significantly in the horizontal direction.

### SUMMARY

The present disclosure provides a pillow presenting increased softness, suppleness, elongatability, and elastic performance in the lateral (horizontal) plane (hereinafter, the “lateral performance parameters”). The weight of the user's head or other body portion when applied to the pillow causes the pillow's surface to conform to the user's head and neck not only due to vertical softness, but also due to the lateral performance parameters. The lateral performance parameters are related to a cleaved configuration. The supportive materials tend to move through deformation to a greater extent in the lateral direction and away from the areas of the greatest load bearing.

In one aspect, a pillow is provided and includes a main body having a top support surface, a bottom support surface and rounded ends joining the top and bottom support surfaces about a rounded profile. The rounded profile of the pillow has no recessed areas where a thickness of the main body decreases progressively towards an edge of the main body. The main body is made of a cellular material. The pillow also includes a plurality of holes defined to extend through the main body and include openings on the top and bottom support surfaces. The holes have a constant circular cross section having a diameter of ⅝ inch or greater.

In another aspect, a pillow is provided including a pad having a thickness, a top support surface, a bottom support surface and rounded ends joining the top and bottom support surfaces about a rounded profile. The pad has no recessed areas where a thickness of the main body decreases progressively towards a single edge of the pad. The pad is made of a cellular material. The pillow also includes a plurality of holes, where each hole has an axial extension transverse to the top and bottom support surfaces and extends through the thickness to define an opening on the top and bottom support surfaces. The plurality of holes have a constant circular cross section and a diameter of ⅝ inch or greater.

In yet another aspect, a method of forming a pillow is provided including providing a pad having a thickness, a top support surface, a bottom support surface and rounded ends joining the top and bottom support surfaces about a constant rounded profile that extends the length and width of the pad, the pad being made of a cellular material; and cleaving a plurality of holes with each hole having an axial extension transverse to the top and bottom support surfaces and extending through the thickness to define an opening on the top and bottom support surfaces, the plurality of holes including a constant circular cross section having a diameter of ⅝ inch or greater.

A more complete understanding of the disclosure can be obtained by reference to the following detailed description of the embodiments thereof in connection with the attached drawings.

### BRIEF DESCRIPTION OF THE DRAWINGS

The above and other objects, features and advantages of the present invention will become more apparent from the following detailed description when taken in conjunction with the accompanying drawings in which:

FIG. 1 is a perspective view of a pillow in accordance with an embodiment;

FIG. 2 is a cross-sectional view of the pillow of FIG. 1 in accordance with an embodiment; and

FIG. 3 is a simplified cross-sectional view of a pillow under compression in accordance with an embodiment.

### DETAILED DESCRIPTION

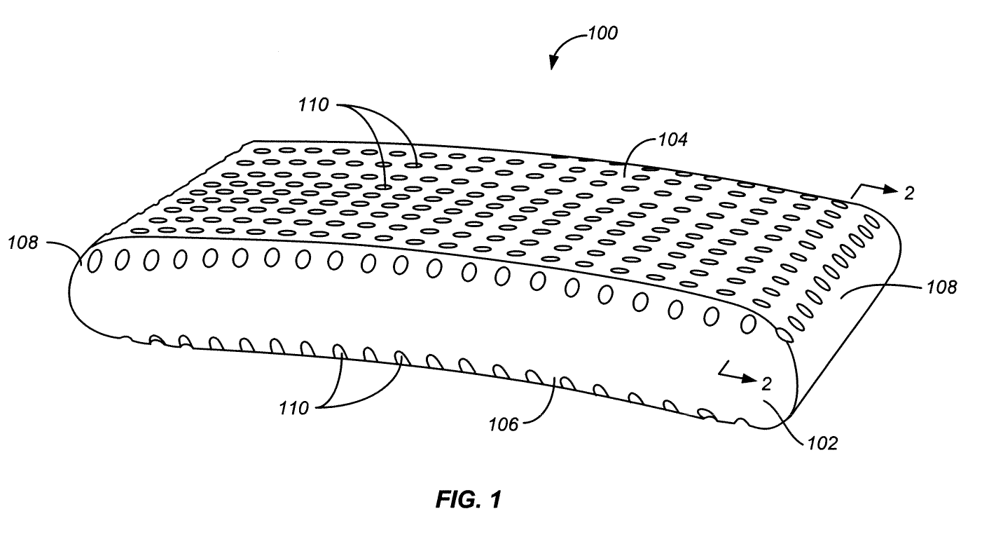

FIG. 1 is an illustration of a pillow 100 in accordance with an embodiment. The pillow 100 includes a main body or pad 102 having a top support surface 104, a bottom support surface 106 and rounded ends 108 joining the top and bottom support surfaces of the pillow 100 particularly about a rounded profile. The top surface 104 and bottom surface 106 provide two flat, opposed support surfaces on the pad 102. The pad 102 may be made of a cellular material, such as polyurethane foam. The pad may have a thickness as desired, for example, the thickness may be between about 2 inches to about 10 inches.

The size of the pillow 100 may vary. It should be understood that the dimensions of pillow 100 may vary, but should be large enough to support the inclusion of large diameter holes as described below. It should also be understood that the pillow 100 has a constant rounded profile that extends the length and width of the pad 102. The rounded ends of the pillow joining the top and bottom support surfaces has no recessed areas where a thickness of the pad decreases progressively towards a single edge of the pad. This means that each edge of the pad has consistently the same rounded profile.

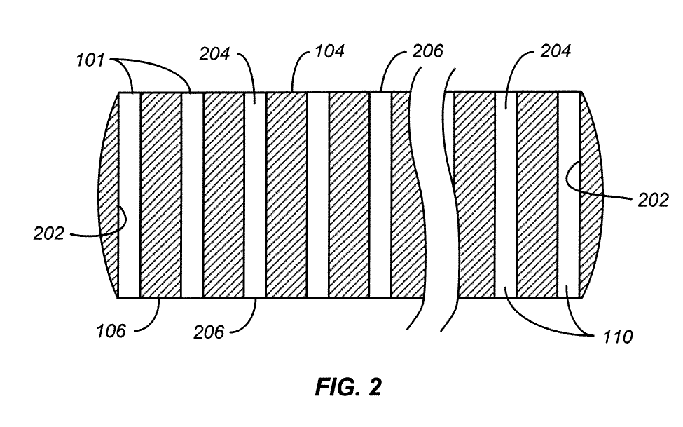

As shown in FIGS. 1 and 2, the pillow 100 includes a plurality of holes or channels 110 defined to extend vertically through the pad 102 between the top surface 104 and the bottom surface 106. Each hole 110 of the plurality of holes, has an axial extension transverse to the top and bottom support surfaces 106 and 108 and extends through the thickness of the pad to define an opening 206 on the top and bottom support surfaces.

In fabricating the pillow 100, the holes 110 are cleaved or cut into the pad 102. The cloven holes 110 are made completely through the entire thickness of the pad 102. As shown FIG. 2, the removal of material from the pad 102 to create the holes 110, exposes sidewalls 202 of the holes 110. The sidewalls 202 define a void or space 204 having an opening on each surface 104 and 106 of the pad. A method of forming the pillow 100 includes providing a pad having a thickness, a top support surface, a bottom support surface and rounded ends joining the top and bottom support surfaces. The plurality of holes are cleaved or cut with each hole having an axial extension transverse to the top and bottom support surfaces and extending through the thickness to define an opening on the top and bottom support surfaces.

It is important that the holes 110 be of a relatively large diameter and are formed completely through the foam pillow 100 to provide the desired higher level of suppleness in the lateral and horizontal directions. In one embodiment, the holes 110 may have a diameter that ranges from between about 0.25 in. to about 1 inch. For example, it has been found that holes 110 with diameters of ⅝ in. or larger, produce a disproportionate softness or suppleness laterally, compared to the vertical softness of the pillow 100. Thus, in one embodiment, the plurality of holes each have a constant circular cross section having a diameter of ⅝ inch or greater. Although the diameters of the holes are at least ⅝ inch, the diameters may be made to vary from each of the other holes.

As shown in FIG. 1, in one embodiment, the holes 110 may be evenly and symmetrically distributed on the pad 102. In alternative embodiments, the holes 110 may be distributed in alternative layouts. For example, the pillow 100 may be made with large holes distributed toward a central area of the pillow, and larger diameter holes toward a peripheral area of the pillow. By varying the diameter of holes 110 and/or their density of distribution, the pillow 100 may be made a more flexible pillow. The variableness of the size and distribution of the holes 110 provides for the mechanical characteristics of the pillow 100 to be maximized for both the vertical softness and horizontal suppleness. In one embodiment, the holes 110 may be distributed from between about 1 inch to about 4 inches on center.

Because there is increased horizontal suppleness created by the large diameter through holes 110, the pillow 110 can provide support to a person sleeping on his stomach, back or side, without a change in the profile of the pillow 100. There is no need to create a recessed or tapered area on the pad, since the pad is capable of supporting the head and neck of a person while being compressed enough on other areas of the pillow to support the shoulders of a person lying on his side, for example.

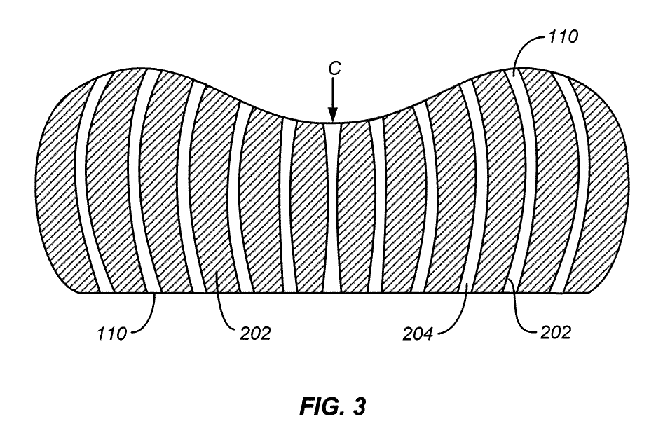

As shown in FIG. 3, when placed under a compressive load C, the side walls 202 of the holes 110 collapse laterally into the space or void 204 created by the holes. The increased diameter holes allows more of the material of the pad 102 to move laterally into the hole space 204 to a degree that not only affects the vertical softness of the pillow, but that enhances the horizontal softness as well.

This inclination toward lateral compression results due to the combined effects of:
(1) Removal of a predetermined amount of material from within the holes 110 (for example, the volume of a cylinder ⅝″ diameter or greater); and
(2) The lateral collapse of the holes 110 into the hole space.

Pillows that function in this manor are a departure from shaped pillows used to produce cervical neck support in the vertical direction that are so common. In the more common pillows, the density of the pillow itself is varied in a discrete manner vertically along the thickness thereof.

The pillow 100 with the larger diameter holes 110 that pass entirely though the pillow, allows for healthy individuals to pull the pillow, for example, laterally into the space between the shoulder and head.

While the present invention has been shown and described with reference to specific embodiments thereof, it will be understood by those skilled in the art that various changes in form and details may be made therein without departing from the spirit and scope of the invention.

What is claimed is:

1. A pillow comprising:
a main body having a top support surface, a bottom support surface and rounded ends joining the top and bottom support surfaces about a rounded profile having no recessed areas where a thickness of the man body decreases progressively towards an edge of the main body, the main body made of a cellular material; and
a plurality of holes defined to extend through the main body and include openings on the top and bottom support surfaces, the holes including a constant circular cross section having a diameter of ⅝ inch or greater.

2. The pillow of claim 1, wherein the plurality of holes are evenly and symmetrically distributed on the main body.

3. The pillow of claim 1, wherein plurality of holes are distributed in non-symmetrically on the main body.

4. The pillow of claim 1, wherein the diameter of each hole is 5/8 inch or greater and varies from each other hole of the plurality of holes.

5. A pillow comprising:
a pad having a thickness, a top support surface, a bottom support surface and rounded ends joining the top and bottom support surfaces about a rounded profile, the pad having no recessed areas where a thickness of the man body decreases progressively towards a single edge of the pad, the pad made of a cellular material; and
a plurality of holes, each hole having an axial extension transverse to the top and bottom support surfaces and extending through the thickness to define an opening on the top and bottom support surfaces, the plurality of holes including a constant circular cross section having a diameter of ⅝ inch or greater.

6. The pillow of claim 5, wherein the plurality of holes are evenly and symmetrically distributed on the pad.

7. The pillow of claim 5, wherein plurality of holes are distributed in non-symmetrically on the pad.

8. The pillow of claim 5, wherein the diameter of each hole varies from each other hole of the plurality of holes.

9. A method of forming a pillow comprising:
providing a pad having a thickness, a top support surface, a bottom support surface and rounded ends joining the top and bottom support surfaces about a constant rounded profile that extends the length and width of the pad, the pad made of a cellular material; and
cleaving a plurality of holes with each hole having an axial extension transverse to the top and bottom support surfaces and extending through the thickness to define an opening on the top and bottom support surfaces, the plurality of holes including a constant circular cross section having a diameter of ⅝ inch or greater.
